(19) United States
(12) Patent Application Publication
(10) Pub. No.: US 2024/0266590 A1
(43) Pub. Date: Aug. 8, 2024

(54) RESTRAINT STRUCTURE FOR BATTERY CELL

(71) Applicant: HONDA MOTOR CO., LTD., Tokyo (JP)

(72) Inventors: Wataru SHIMIZU, Saitama (JP); Yuta URUSHIYAMA, Saitama (JP)

(21) Appl. No.: 18/544,443

(22) Filed: Dec. 19, 2023

(30) Foreign Application Priority Data
Feb. 2, 2023 (JP) 2023-014822

(51) Int. Cl. H01M 10/04; H01M 50/103; H01M 50/131; H01M 50/15

(52) U.S. Cl. CPC H01M 10/0468; H01M 50/103; H01M 50/131; H01M 50/15

(57) ABSTRACT

A restraint structure for a battery cell capable of uniformly pressurizing a battery cell that is a laminate, and capable of alleviating a variation in a pressurizing force due to a change in a volume of a battery. The restraint structure for a battery cell includes a mounting base, an elastic member, and a restraint member. The battery cell is a laminate having a substantially rectangular parallelepiped shape. The elastic member has surfaces respectively disposed to face five surfaces other than a mounting surface of the battery cell. The battery cell, the mounting base, and the elastic member are housed in and restrained by the restraint member. The restraint member has contact surfaces in contact with the elastic member. The contact surfaces include a contact surface that faces the elastic member in a laminating direction of the battery cell and that has a recess formed therein.

This application is based on and claims the benefit of priority from Japanese Patent Application No. 2023-014822, filed on 2 Feb. 2023, the content of which is incorporated herein by reference.

### BACKGROUND OF THE INVENTION

### Field of the Invention

The present invention relates to a restraint structure for a battery cell.

### Related Art

In recent years, research and development have been conducted on secondary batteries that contribute to energy efficiency in order to ensure that more people have access to affordable, reliable, sustainable, and advanced energy.

Examples of such a secondary battery include a liquid battery in which an electrolytic solution and a separator are disposed between a positive electrode and a negative electrode, and a solid-state battery including a solid electrolyte instead of an electrolytic solution. A plurality of the above-described structures are laminated to be used as a laminated battery. A laminated battery is pressurized and restrained at the top and bottom surfaces in a laminating direction, which reduces the distribution of resistance within the electrode surface and makes the reaction uniform. Thus, there is known a technique of pressurizing a battery laminate housed in an exterior body in a laminating direction (for example, see Patent Document 1).

Patent Document 1: Japanese Unexamined Patent Application, Publication No.2018-133175

### SUMMARY OF THE INVENTION

In the pressurized restraint method of pressing uniaxially from the top and bottom surfaces as disclosed in Patent Document 1, the uniformity of the reaction is insufficient, and thus there are possibilities that not only good initial characteristics and durability may not be obtained, but also the yield rate may be low. Furthermore, there is a possibility that the battery characteristics may become non-uniform due to a change in the pressurizing force due to a change in the volume of the battery.

In response to the above issues, an object of the present invention is to provide a restraint structure for a battery cell capable of uniformly pressurizing a battery cell that is a laminate, and capable of alleviating a variation in a pressurizing force due to a change in a volume of a battery.

(1) A first aspect of the present invention relates to a restraint structure for a battery cell, including a mounting base for mounting the battery cell, an elastic member, and a restraint member. The battery cell is a laminate having a substantially rectangular parallelepiped shape. The battery cell is mounted on the mounting base. The elastic member has surfaces respectively disposed to face five surfaces other than a mounting surface of the battery cell. The battery cell, the mounting base, and the elastic member are housed in and restrained by the restraint member. The restraint member has contact surfaces in contact with the elastic member. The contact surfaces include a contact surface that faces the elastic member in a laminating direction of the battery cell and that has a recess formed therein.

According to the first aspect of the invention, it is possible to provide the restraint structure for a battery cell capable of uniformly pressurizing the battery cell that is a laminate, and capable of alleviating a variation in the pressurizing force due to a change in the volume of the battery.

(2) In a second aspect of the invention according to the first aspect, the surfaces of the elastic member include a surface that faces a laminated end surface of the battery cell and that has a bulged central part in the laminating direction of the battery cell.

According to the second aspect of the invention, when pressure is applied to the battery cell and the elastic member in the laminating direction, bulging of the laminated end surface of the battery cell can be suppressed.

(3) In a third aspect of the invention according to the first or second aspect, the contact surfaces include contact surfaces that respectively face laminated end surfaces of the battery cell. At least one of the contact surfaces that respectively face the laminated end surfaces of the battery cell has a recess formed therein.

According to the third aspect of the invention, even in the direction perpendicular to the laminating direction of the battery cell, it is possible to alleviate a variation in the pressurizing force due to a change in the volume of the battery cell.

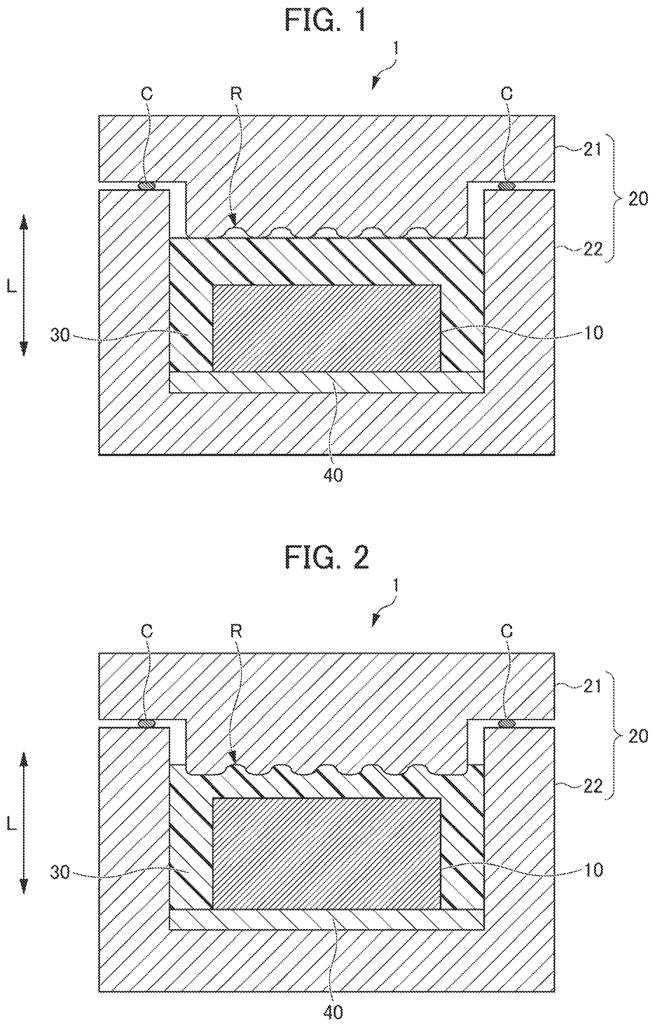

FIG. 1 is a sectional view showing a restraint structure for a battery cell according to an embodiment of the present invention;

FIG. 2 is a sectional view showing the restraint structure for a battery cell according to the embodiment of the present invention;

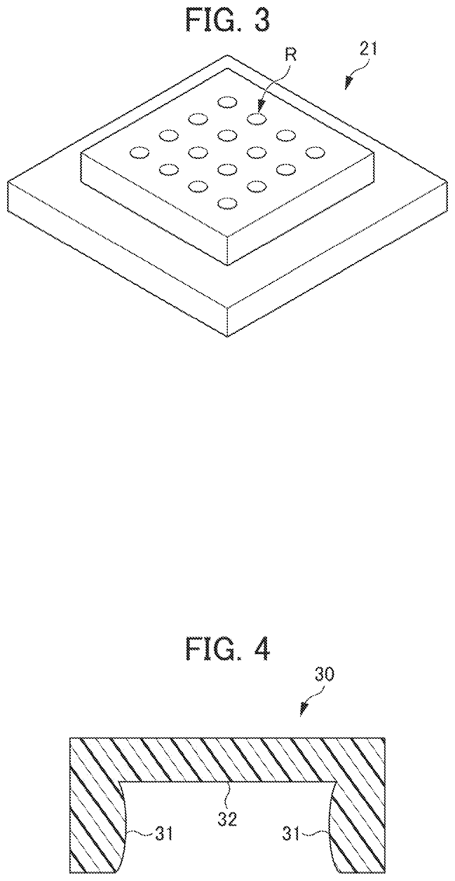

FIG. 3 is a perspective view showing a restraint member according to the present embodiment; and

FIG. 4 is a sectional view showing an elastic member according to the present embodiment.

### DETAILED DESCRIPTION OF THE INVENTION

### Restraint Structure for Battery Cell

A restraint structure for a battery cell according to an embodiment of the present invention will be described with reference to the drawings. A restraint structure 1 for a battery cell (hereinafter, also referred to as “restraint structure 1”) can uniformly pressurize a battery cell 10, and can alleviate a variation in the pressurizing force due to a volume change due to charging and discharging of the battery cell 10. FIG. 1 is a sectional view of the restraint structure 1 according to the present embodiment. As shown in FIG. 1, the restraint structure 1 includes a mounting base 40 for mounting a battery cell, an elastic member 30, and a restraint member 20.

### (Battery Cell)

The battery cell 10 according to the present embodiment includes a laminate in which a positive electrode layer and a negative electrode layer are laminated with an electrolyte interposed therebetween. The positive electrode layer and the negative electrode layer each have a substantially rectangular sheet shape in plan view, and are laminated in a laminating direction L in FIG. 1. The battery cell 10 may be a secondary battery in which an electrolytic solution and a separator are disposed between the positive electrode layer and the negative electrode layer. The battery cell 10 is preferably a solid-state secondary battery in which a solid electrolyte is disposed between the positive electrode layer and the negative electrode layer from the viewpoint of applying a uniform restraint pressure to each surface by the restraint member 20. The number of laminated layers for each of the above layers is not limited. The laminate is housed in an exterior body such as a laminate film. The battery cell 10 configured as described above has a substantially rectangular parallelepiped shape. The battery cell 10 may have a rectangular parallelepiped shape.

The positive electrode layer and the negative electrode layer each include, for example, a current collector and an electrode active material. One or more sets of current collectors are electrically connected to electrode terminals (not shown). The electrode terminal, for example, extends from a lower part of the battery cell 10 in FIG. 1, laterally along the mounting base 40, and outward from a hole formed in the restraint member 20. The above is an example of the configuration of the electrode terminal, and the configuration of the electrode terminal is not limited to the above configuration.

The specific configuration of each of the positive electrode layer, the negative electrode layer, and the electrolyte is not limited, and each of the positive electrode layer, the negative electrode layer, and the electrolyte can include a known material as a material of a secondary battery.

### (Restraint Member)

The restraint member 20 has a space in which the battery cell 10, the elastic member 30, and the mounting base 40 can be housed, and includes a lid part 21 and a main body part 22. The restraint member 20 includes a rigid member such as metal, which is difficult to deform by an external force.

As shown in FIG. 1, the restraint member 20 is configured such that a part of the lid part 21 is inserted into the internal space of the main body part 22 and comes into contact with the elastic member 30; the battery cell 10, the elastic member 30, and the mounting base 40 are housed in the internal space of the main body part 22; and the main body part 22 and the lid part 21 are joined to each other by a joining part C, whereby a restraint pressure is applied to the battery cell 10 via the elastic member 30. The joining method for the joining part C may be joining by welding or joining by bolts.

As shown in FIGS. 1 to 3, the lid part 21 has a shape in which a part of a plate-shaped surface protrudes, and the protruding part is inserted into the main body part 22 so that the lid part 21 can contact the elastic member 30. The contact surface of the lid part 21 that contacts the elastic member 30 faces the elastic member 30 in the laminating direction L of the battery cell 10, and has a plurality of recesses R formed therein.

The function of the recess R will be described below. FIG. 1 shows a state immediately after the battery cell 10, the elastic member 30, and the mounting base 40 are housed in the restraint member 20. In this state, a predetermined restraint pressure is applied to the battery cell 10, and the elastic member 30 contacts part of the contact surface of the lid part 21, but a space is formed between the elastic member 30 and the lid part 21 by the recess R.

FIG. 2 shows a state in which the volume of the battery cell 10 has increased when the battery cell 10 is charged. In this state, if the battery cell 10 is directly restrained by the restraint member in which the elastic member 30 and the recesses R do not exist, an additional pressurizing force is applied to the battery cell 10 due to the increased volume. In this case, there is a possibility that the variation in the resistance within the electrode surface may increase. However, by employing the restraint structure 1 of the present embodiment, when the volume of the battery cell 10 increases and the pressurizing force applied to the battery cell 10 and the elastic member 30 becomes larger than the initial pressurizing force, as shown in FIG. 2, the elastic member 30 is elastically deformed to enter the spaces formed by the recesses R. When the battery cell 10 contracts during discharging, the elastic member 30 elastically deforms and returns to the state shown in FIG. 1. As a result, the variation in the pressurizing force due to the volume change of the battery cell 10 is alleviated, so that the variation in the resistance within the electrode surface is reduced, and the initial characteristics and durability of the battery cell 10 are greatly improved. Furthermore, since the tolerance of the restraint pressure is reduced, components can be made smaller and lighter.

Although the recesses R are formed in 4×4 rows in FIG. 3, the arrangement and the number of recesses are not limited to the aspect shown in FIG. 3. However, from the viewpoint of uniformly applying the restraint pressure, the recesses R are preferably formed uniformly over the entire contact surface. The shape of the recess R is formed by a curved surface in FIGS. 1 to 3, so that the elastically deformed elastic member 30 can easily enter the space formed by the recess R. On the other hand, the shape of the recess R is not limited to the above as long as it is a shape in which a space can be formed between the contact surface of the lid part 21 and the elastic member 30. For example, a plurality of convex parts may be formed on the contact surface of the lid part 21, and a recess may be formed between the convex parts.

The main body part 22 has an internal space in which the battery cell 10, the elastic member 30, and the mounting base 40 can be housed, and has a housing-like shape with one side open. The internal space of the main body part 22 is a substantially rectangular parallelepiped space corresponding to the size of the battery cell 10, the elastic member 30, and the mounting base 40. The mounting base 40 is disposed on the bottom surface of the internal space, the battery cell 10 is then mounted on the mounting base 40, and the elastic member 30 is disposed so as to cover five surfaces other than the mounting surface of the battery cell 10. Next, the lid part 21 is disposed such that the surface on which the recesses R are formed contacts the top surface of the elastic member 30, and the lid part 21 and the main body part 22 are joined to each other by the joining part C in a state where a predetermined restraint pressure is applied. As described above, the respective members are housed and restrained in the internal space of the main body part 22.

Among the contact surfaces of the restraint member 20 in contact with the elastic member 30 in the internal space of the main body part 22, a recess may be formed in any of contact surfaces that respectively face the laminated end surfaces of the battery cell 10. The configuration of the formed recess may be the same as that of the above recess R. In the present embodiment, the above-described any of contact surfaces means four side surfaces other than the bottom surface of the internal space. According to the above configuration, even in the direction perpendicular to the laminating direction L, it is possible to alleviate a variation in the pressurizing force due to a change in the volume of the battery cell 10.

The shape of the main body part 22 is not limited as long as it is a shape in which an internal space capable of housing the above-described members is formed. The main body part 22 may be integrally formed, or may be formed by joining a plurality of members.

### (Elastic Member)

The elastic member 30 is disposed so as to face five surfaces other than the mounting surface of the battery cell 10. The elastic member 30 is preferably disposed without a gap so as to cover the surfaces other than the mounting surface of the battery cell 10. The elastic member 30 is disposed as described above, and is housed in and restrained by the restraint member 20, together with the battery cell 10. That is, in a state in which the elastic member 30 is housed in the restraint member 20, the elastic member 30 is compressed by the restraint pressure, and is in close contact with the battery cell 10 and the restraint member 20. Thus, a uniform restraint pressure can be applied to each surface of the battery cell 10.

The elastic member 30 includes a material that has a predetermined elastic modulus and can be deformed by an external force. The elastic modulus of the elastic member 30 is lower than that of the restraint member 20 and the mounting base 40. The elastic member 30 may include, for example, a rubber material, an elastomer material, a gel material, or the like.

The elastic member 30 may have, for example, a box shape with one side open corresponding to the size of the battery cell 10, and may be integrally formed such that the battery cell 10 can be disposed on the inner surface. Alternatively, the elastic member 30 may be a combination of a plurality of members.

As shown in FIG. 4, the elastic member 30 has surfaces 31 facing the laminated end surfaces of the battery cell 10 and a surface 32 facing the laminated top surface of the battery cell 10. In the present embodiment, four surfaces 31 and one surface 32 are formed. As shown in FIG. 4, the surface 31 preferably has a bulged central part in the laminating direction Ll of the battery cell 10. When the surface 31 is configured in this manner and the battery cell 10 and the elastic member 30 are housed in the restraint member 20, they are housed such that the surface 31 contacts the laminated end surface of the battery cell 10 while being elastically deformed. Accordingly, a predetermined pressure is applied to the laminated end surface of the battery cell 10 in the initial state. Thus, pressure can be applied to the battery cell 10 and the elastic member 30 in the laminating direction L. In this case, bulging of the laminated end surface of the battery cell 10 can be suppressed.

### (Mounting Base)

The battery cell 10 is mounted on the mounting base 40. The mounting base 40 includes a rigid member such as a metal or a hard resin that is difficult to deform by an external force. The mounting base 40 is formed in a plate shape.

Although a preferred embodiment of the present invention has been described above, the present invention is not limited to the above embodiment, and various modifications and improvements are possible to the extent that the object of the present invention can be achieved.

### EXPLANATION OF REFERENCE NUMERALS

1 restraint structure for battery cell
10 battery cell
20 restraint member
30 elastic member
40 mounting base
L laminating direction
R recess

What is claimed is:

1. A restraint structure for a battery cell, comprising:
a mounting base for mounting the battery cell; an elastic member; and a restraint member,
the battery cell being a laminate having a substantially rectangular parallelepiped shape,
the elastic member having surfaces respectively disposed to face five surfaces other than a mounting surface of the battery cell,
the battery cell, the mounting base, and the elastic member being housed in and restrained by the restraint member, and
the restraint member having contact surfaces in contact with the elastic member, the contact surfaces comprising a contact surface that faces the elastic member in a laminating direction of the battery cell and that has a recess formed therein.

2. The restraint structure for a battery cell according to claim 1, wherein the surfaces of the elastic member comprise a surface that faces a laminated end surface of the battery cell and that has a bulged central part in the laminating direction of the battery cell.

3. The restraint structure for a battery cell according to claim 1, wherein the contact surfaces comprise contact surfaces that respectively face laminated end surfaces of the battery cell, and at least one of the contact surfaces that respectively face the laminated end surfaces of the battery cell has a recess formed therein.
